(19) United States
(12) Patent Application Publication
(10) Pub. No.: US 2006/0113398 A1
(43) Pub. Date: Jun. 1, 2006

(54) Temperature control with induced airflow

(75) Inventor: Nicholas Ashworth, Dublin, OH (US)

Correspondence Address: REINHART BOERNER VAN DEUREN LTD., 483 NORTH MULFORD ROAD, SUITE 7, ROCKFORD, IL, 61107, US

(73) Assignee: Ranco Incorporated of Delaware, Wilmington, DE (US)

(21) Appl. No.: 11/288,757

(22) Filed: Nov. 29, 2005

Related U.S. Application Data
(60) Provisional application No. 60/632,318, filed on Nov. 30, 2004.

(51) Int. Cl. G05D 23/12; F24F 3/14; F24F 7/00

(52) U.S. Cl. 236/44 C; 236/1 C; 236/49.3

(57) ABSTRACT

A thermostat comprising a body, a passage, and at least one corona discharge apparatus is provided. The passage passes through the body and extends between an inlet and an outlet. The corona discharge apparatus is positioned within the passage to draw air into the passage through the inlet and to expel the fluid through the outlet such that the thermostat is able to sense the actual ambient air within the structure within which it is mounted without having to rely on free rise convection of the air. As such, the thermostat is able to be flush mounted in a wall or other structure.

This patent application claims the benefit of U.S. Provisional Patent Application No. 60/632,318, filed Nov. 30, 2004, the teachings and disclosure of which are hereby incorporated in their entireties by reference thereto.

### FIELD OF THE INVENTION

This invention generally relates to a thermostat and, more particularly, to air flow through the thermostat.

### BACKGROUND OF THE INVENTION

One of the issues that a modern wall thermostat faces is correlating a temperature sensed by an internal temperature sensor (e.g., a thermistor) to an actual ambient temperature of an environment. If the sensed temperature is very different than the actual ambient temperature, the thermostat will not control a heating ventilation and air conditioning (HVAC) system in the most desirable or efficient manner. Therefore, ensuring that the sensed temperature is the same as, or very nearly the same as, the ambient temperature in a thermostatically controlled environment is important. Unfortunately, this task often presents significant challenges.

For one, thermostats are known to have a relatively large thermal mass. Therefore, any heat retained by the thermostat may be sensed by, and may undesirably influence, the internal temperature sensor. Besides having a large thermal mass, thermostats can contain components that generate heat. If enough heat is produced, the internal temperature sensor may be adversely affected such that the device is not able to provide a correct temperature reading.

In addition, the position and/or location where the conventional thermostat can be mounted is often limited due to the operational requirements of the thermostat. In most cases, the conventional thermostat relies upon convection (i.e., free rise convection) to move air by an internal temperature sensor. Therefore, the thermostat is usually mounted to a wall, as depicted in FIG. 1, such that the thermostat juts out into the environment. As those skilled in the art will appreciate, air movement near the wall due to convection is poor (i.e., the closer that air gets to the wall, the more static the movement of that air becomes). Due to the small degree of convection at and very near the wall, the internal temperature sensor of the thermostat may very well only be exposed to a small portion of the air in the environment instead of a representative sample. As such, the temperature sensed by the thermostat and used to instruct the HVAC might not be accurate relative to the ambient temperature.

As may be seen in FIG. 1, a conventional thermostat 10 as known in the art is generally mounted to a wall 12 of a structure 14 such that the device 10 projects outwardly into the environment. Although not shown, the thermostat 10 is operatively coupled to a heating, ventilation and air conditioning (HVAC) system such that temperature, humidity, or other parameters of the environment within the structure is thermostatically controlled. As noted above, the thermostat 10 relies, at least in part, upon free rise convection to ensure that a temperature sensed by an internal sensor (not shown) closely correlates with an actual ambient temperature in the environment and that the HVAC system is appropriately operated.

Since the traditional thermostat 10 relies on convection to move air past the temperature sensor, the thermostat 10 must extend away from a surface of the wall 12 and project into the environment. Such an arrangement forecloses the possibility of flush mounting the thermostat in the wall 12. To some, a flush mount may be a more aesthetically pleasing way to secure the thermostat to the wall 12.

Therefore, a thermostat that can improve the correlation of a sensed temperature to an ambient temperature in an environment and be mounted in an aesthetically pleasing manner would be desirable. The invention provides such a thermostat. These and other advantages of the invention, as well as additional inventive features, will be apparent from the description of the invention provided herein.

### BRIEF SUMMARY OF THE INVENTION

The invention provides a new and improved thermostat that accurately determines the actual ambient temperature of the living space by inducing airflow through the thermostat. The induced airflow also exhausts any self-heated air and/or residual warm air within the enclosure. The invention also provides a new and improved thermostat that may be mounted flush with a surface of a wall.

In one aspect, the invention provides a thermostat. The thermostat comprises a body, an environmental condition sensor, and at least one corona discharge apparatus. The body defines a passage therethrough and extending between an inlet and an outlet. The environmental condition sensor is positioned within the passage. The at least one corona discharge apparatus is positioned within the passage to draw air into the passage through the inlet and to expel the air through the outlet.

In another aspect, the invention provides a thermostat. The thermostat comprises a passage, a temperature sensor, an emitter array, and a collector array. The passage extends between an inlet and an outlet. The temperature sensor is disposed within the passage. The emitter array is positioned in the passage. The collector array is positioned in the passage and in spaced relation to the emitter array. The emitter array and the collector array cooperatively produce an electric wind in the passage when energized such that air is drawn from an environment into the passage through the inlet, moved past the temperature sensor, and expelled through the outlet into the environment.

In yet another aspect, the invention provides a method of controlling a temperature in a structure. The method comprises the step of producing an electric wind in a passage of a thermostat thereby drawing air from an environment into the passage. The air is then circulated past a temperature sensor of the thermostat. Next, the fluid is expelled into the environment such that the temperature of the air is monitored.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic view of a conventional thermostat as traditionally mounted to a wall inside an environment; and

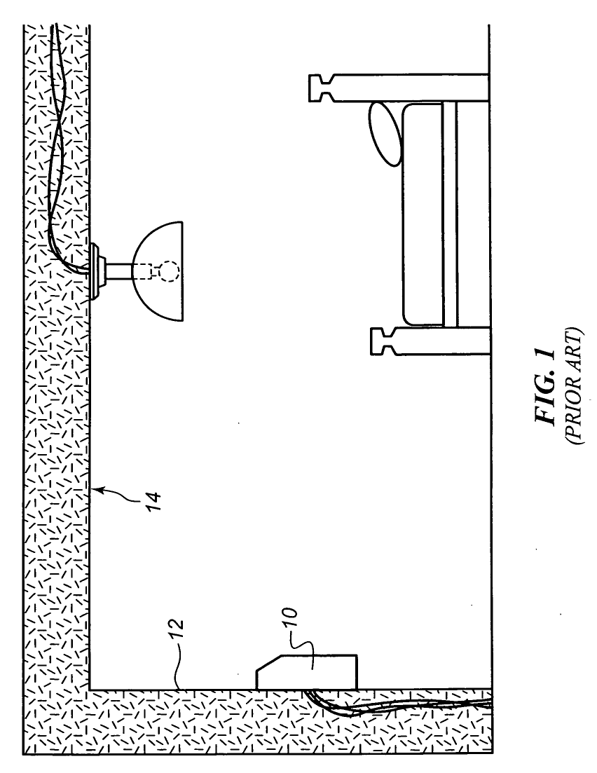

FIG. 2 is a simplified schematic view of an exemplary embodiment of a flush mounted thermostat constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

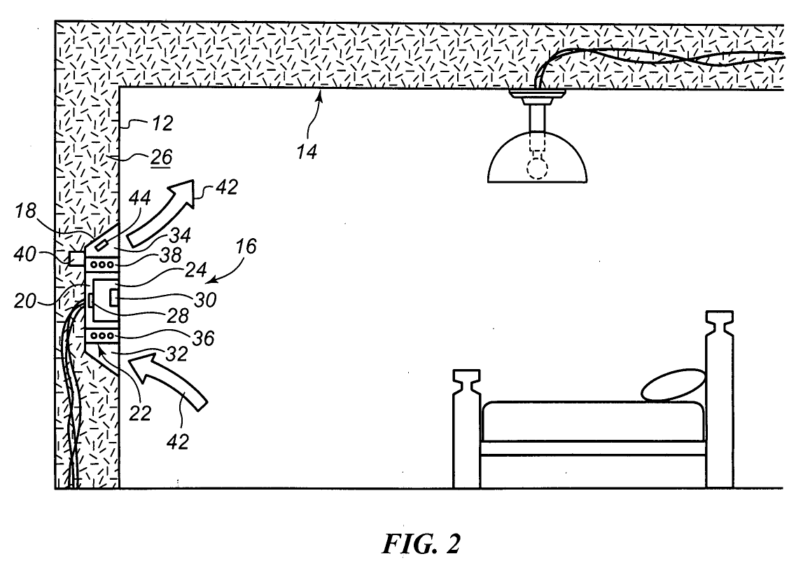

Referring now to FIG. 2, a thermostat 16 constructed in accordance with the teachings of the present invention is illustrated. The thermostat 16 comprises a body 18, a passage 20, and at least one corona discharge apparatus 22. The body 14 is preferably constructed of a material such as steel, plastic, and the like. In a preferred embodiment as shown in FIG. 2, the body 14 is configured to be mounted within the wall 12 of the structure 14 such that the front face 24 of the thermostat 16 is planar with an exterior surface 26 of the wall. In other words, the thermostat 16 is flush mounted in the wall 12. The body 14 generally houses at least one sensor 28, one or more control components 30, and a passage 20.

The sensor 28 is able to sense one or more parameters of the environment within the structure 14 such as, for example, a temperature, a humidity level, and the like. Preferably, the sensor 28 is disposed within, adjacent to, and/or in close proximity to the passage 20 so as to allow the sensor 28 to sense such parameters from the air moving through the passage 20. In one embodiment, the sensor 28 is a temperature sensor disposed within the passage 20, e.g. a thermistor.

The control components 30 are devices used to control the operation and features of the thermostat 16 and the HVAC system. The control components 30 are preferably located on or in body 18 of the thermostat 16 in a manner permitting easy access for a user. The control components 30 may include user interface components, for example, one or more knobs, switches, depressible buttons, rotating dials, touch screens, and the like, and may include processing components, for example, a microprocessor, PLC, analog circuitry, etc. In one embodiment, the control components 30 can be covered and/or protected by a sliding door or pivoting cover.

The passage 20 is generally formed in the body 18 and extends between an inlet 32 and an outlet 34. The inlet 32 and outlet 34 each open through the front face 24 of the body 18 as shown in FIG. 2. Each of the inlet and outlet 32, 34 can be protected by a cover, a grate, and the like. At least a portion of the passage 20 is proximate and/or adjacent the temperature sensor 28 such that the temperature sensor can sense a temperature of the fluid moving through, or temporarily residing in, the passage 20. Preferably, the temperature sensor 28 is disposed within the passage 20.

The passage 20 also houses one or more corona discharge apparatuses 22. Each of the corona discharge apparatuses 22 in the passage 20 is an electrical device that relies on corona discharge and ion charge attraction to move air and, preferably, filter particles and pollutants from the air. In the illustrated embodiment of FIG. 2, only one corona discharge apparatus 22 is shown in the passage 20, although more may be used.

A typical corona discharge apparatus 22 employs numerous corona discharge electrodes 36 arranged in arrays and spaced apart from numerous negatively charged attracting electrodes 38 that are also arranged in arrays. When assembled into an array, the corona discharge electrodes 36 can be referred to as an emitter array. Likewise, the attracting electrodes 38 can be referred to a collector array. Due to the many array configurations and electrode shapes that can be used, the arrays of the corona discharge electrodes 36 and the attracting electrodes 38 have been shown in FIG. 2 in a simplified form.

Each of the corona discharge electrodes 36 and attracting electrodes 38 is coupled to and charged by a high-voltage power supply 40. The corona discharge electrodes 36 are typically asymmetrical with respect to the attracting electrodes 38. In one embodiment, the corona discharge electrodes 36 are highly curved and resemble the tip of a needle or a narrow wire while the attracting electrodes 38 take the form of a flat plate or a ground plane. The curvature of the corona discharge electrodes 36 ensures a high potential gradient around that electrode.

The high potential gradient generated at or near the corona discharge electrodes 36 basically pulls apart the neutral air molecules in the immediate area. What remains after each neutral air molecule has been dismantled is a positively charged ion and a negatively charged electron. Due to the strong electric field near the corona discharge electrode 36, the ion and electron are increasingly separated from each other, prevented from recombining, and accelerated. Therefore, the ion and electron are both imparted with kinetic energy. Moreover, since a portion of the air molecules in the passage 20 is ionized, the air in the passage becomes a conducting medium, the circuit including the corona discharge electrodes 36 and the attracting electrodes 38 is completed, and a current flow can be sustained.

The negatively charged electrons are persuaded to move toward the positively charged corona discharge electrodes 36 due to the difference in charge between them. When the rapidly moving and accelerating electrons collide with other neutral air molecules in the area, further positive ion/electron pairs are created. As more and more positive/ion electric pairs are produced, an electron avalanche is established. The electron avalanche sustains and/or perpetuates the corona discharge process.

In contrast to the negatively charged electrons, the positively charged ions are persuaded to move from near the corona discharge electrodes 36 toward the attracting electrodes 38. This movement is due to the difference in charge between the positively charged ions and the negatively charged attracting electrodes. Like the electrons, when the positively charged ions move they also collide with neutral air molecules. When they collide, the positively charged ions can transfer some of their momentum as well as excess charge to the neutral air molecules. Therefore, the neutral air molecules are knocked toward the attracting electrode 38 or are ionized and then drawn to the attracting electrode. In either case, the positively charged ions and other air molecules end up flowing from the corona discharge electrodes 36 toward the attracting electrodes 38.

The movement or flow of the air particles away from the corona discharge electrodes 36 and toward the attracting electrodes 38 causes or results in what is referred to by those skilled in the art as an electric wind or electrostatic fluid acceleration. In the illustrated embodiment of FIG. 2, the electric wind travels through the passage 20 in a direction depicted by arrows 42.

In one embodiment, the velocity and volume of the air moving through the passage 20 is proportional to the voltage difference between the electrodes 36, 38 and the size of the arrays. By varying the potential between the electrodes 36, 38, the size and dimensions of the passage, and the like, the velocity and volume of the electric wind can be increased and decreased over a continuous range as desired. In any particular configuration, this range may be adjusted by varying the electric potential between the electrodes 36, 38.

When the positively charged ions creating the electric wind reach the attracting electrodes 38, the positive charge is removed by permitting a recombination of the negatively charged electrons with the positively charged ions. Due to the recombination, neutral air molecules once again exist in the passage 20. Advantageously, these neutral air molecules retain their velocity and direction.

In a preferred embodiment, one or more corona discharge apparatuses 22 can be disposed within the passage 20 for the purpose of cleaning and scrubbing the air. Such beneficial and desirable filtering can be performed in addition to generating the electric wind. As known to those skilled in the art, contaminants and particles tend to adhere to the attracting electrode 38 during the corona discharge process. Therefore, the air passing through the passage 20 can be purified. The attracting electrodes 38, which are often plates, are preferably removable to permit inspection, cleaning, and replacement. In an alternative embodiment, the entire corona discharge apparatus 22 is removable.

As is known in the art, several patents and published applications have recognized that corona discharge devices may be used to generate ions and accelerate and filter fluids such as air. Such patents and published applications that describe fluid and/or air moving devices and technology include the following U.S. Pat. Nos. 3,638,058, 3,699,387, 3,751,715, 4,210,847, 4,231,766, 4,380,720, 4,643,745, 4,789,801, 5,077,500, 5,667,564, 6,176,977, 6,504,308, 6,664,741, and 6,727,657 and U.S. Pub. Pat. Applns. 2004/40217720, 2004/0212329, 2004/0183454, 2004/0155612, 2004/0004797, 2004/0004440, 2003/0234618, and 2003/0090209. The teachings and disclosure of each of these patents and published applications are incorporated in their entireties by reference thereto.

While other ion discharge or corona fluid movement technologies may be employed in the system and method of the present invention, a preferred embodiment of the present invention utilizes the technology described in one or more of the preceding patents and/or published applications, and most preferably, the technology described in U.S. Pat. Nos. 6,504,308, 6,664,741, and 6,727,657 issued to Kronos Advanced Technologies, Inc., of Belmont, Mass. The teachings and disclosure of each of these patents are also incorporated in their entireties by reference thereto.

In a preferred embodiment, the thermostat 16 further comprises an ozone depletion apparatus 44 for reducing the amount of ozone in the fluid. In general, the ozone depletion apparatus 44 is any system, device, or method having the ability to degenerate ozone into oxygen (i.e., dioxide) and/or absorb ozone. In particular, the ozone depletion apparatus 44 can be a filter, a catalyst composition situated proximate the fluid, and the like. When the thermostat 16 is equipped with the ozone depletion apparatus 44, the ozone generated by the one or more corona discharge apparatuses 22 can be maintained below a desired level, relegated to within a predetermined range, and otherwise managed.

While the ozone depletion apparatus 44 can be situated in a variety of different locations relative to the one or more corona discharge apparatuses 22, the ozone depletion apparatus is preferably disposed within the passage 20 proximate the outlet 34. In an exemplary embodiment, the ozone depletion apparatus 44 is generally downstream of the last corona discharge apparatus 22 in the thermostat 16. As such, air flowing out of the outlet 34 is purified by the ozone depletion apparatus 44 prior to entering the environment.

As is known in the art, several patents have recognized that ozone depletion devices and systems may be used to convert ozone to oxygen, absorb ozone, and the like. Such patents that describe converting and absorbing devices, methods, and technology include the following U.S. Pat. Nos. 4,343,776, 4,405,507, 5,422,331, 6,375,902, 6,375,905, and 6,699,529. The teachings and disclosure of each of these patents and published applications are incorporated in their entireties by reference thereto.

In operation, and referring to FIG. 2, air is drawn into the passage 20 of the thermostat 16 through the inlet 32 due to the activation of one or more of the corona discharge apparatuses 22 and the corona discharge process as discussed above. Once drawn inside the passage 20, the air continues to move through the passage 20 in the direction indicated by the arrows 42. While flowing through the passage 20, the air is circulated and generally moved past the sensor 28 such that the sensor can sense, measure, and/or monitor one or more of a temperature, a humidity, and/or other environmental parameter.

After the air flowing through the passage 20 has been directed by the sensor 28, the air is expelled and/or exhausted into the environment through the outlet 34 by the corona discharge process. Since at least one condition of the air has been sensed, the thermostat 16 is able to manage the HVAC system to thermostatically control the environment within the structure 14. In a preferred embodiment, at least one of the corona discharge apparatuses 22 that can be employed in the thermostat 16 also filters and cleans the air traveling through the passage 20 of the thermostat 16, which will aid in keeping the sensor 28 clean and able to properly sense the desired environmental condition(s).

By drawing air from the environment into the thermostat 16, the thermostat 16 is better able to sense the actual ambient temperature within a dwelling, instead of relying on free rise convection to move air through the thermostat. This lowers the thermal mass of the thermostat 16 and increases the thermostat's ability to rapidly sense actual changes in temperature, etc. within the dwelling.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat comprising:
a body defining a passage therethrough and extending between an inlet and an outlet;
an environmental condition sensor positioned within the passage; and
at least one corona discharge apparatus positioned within the passage to draw air into the passage through the inlet and to expel the air through the outlet.

2. The thermostat of claim 1, wherein the environmental sensor senses at least one of a temperature and a humidity of the air.

3. The thermostat of claim 1, further comprising means operatively coupled to the at least one corona discharge apparatus for varying a flow rate of the fluid through the passage.

4. The thermostat of claim 1, further comprising a touch screen user interface.

5. The thermostat of claim 1, wherein the thermostat is adapted for flush mounting in a wall.

6. The thermostat of claim 1, wherein the thermostat further comprises an ozone depletion apparatus for removing ozone from the fluid.

7. The thermostat of claim 1, further comprising control components operatively coupled to the environmental condition sensor, and wherein the passage is configured to exhaust heat generated by the control components.

8. The thermostat of claim 1, wherein the at least one corona discharge apparatus comprises at least one electrode array that is removably mounted in the passage.

9. The thermostat of claim 1, wherein the at least one corona discharge apparatus permits a variable flow of the air to flow through the thermostat.

10. The thermostat of claim 1, wherein the at least one corona discharge apparatus comprises an emitter array in spaced relation to a collector array.

11. The thermostat of claim 1, wherein the environmental condition sensor is a thermistor.

12. The thermostat of claim 1, wherein the at least one corona discharge apparatus is removably positioned in the passage to allow cleaning thereof.

13. The thermostat of claim 1, further comprising a high voltage power supply operatively coupled to the at least one corona discharge apparatus.

14. A thermostat, comprising:
a passage extending between an inlet and an outlet;
a temperature sensor disposed within the passage;
an emitter array positioned in the passage; and
a collector array positioned in the passage and in spaced relation to the emitter array, the emitter array and the collector array cooperatively producing an electric wind in the passage when energized such that air is drawn from an environment into the passage through the inlet, moved past the temperature sensor, and expelled through the outlet into the environment.

15. The thermostat of claim 14, wherein the positively charged emitter array and the negatively charged collector array are disposed proximate the inlet.

16. The thermostat of claim 15, wherein the thermostat further comprises a second emitter array and a second collector array in spaced relation to the second emitter array, the second emitter array and the second collector array disposed proximate the outlet.

17. The thermostat of claim 14, wherein the temperature sensor is a thermistor.

18. A method of controlling a temperature in a structure, comprising the steps of:
producing an electric wind in a passage of a thermostat thereby drawing air from an environment into the passage;
circulating the air past a temperature sensor of the thermostat; and
expelling the fluid into the environment such that the temperature of the air is monitored.

19. The method of claim 18, wherein the method further comprises the step of filtering the air to remove ozone in the electric wind.

20. The method of claim 18, further comprising the step of filtering the air prior to reaching the temperature sensor.
